(19) United States
(12) Patent Application Publication
(10) Pub. No.: US 2018/0006993 A1
(43) Pub. Date: Jan. 4, 2018

(54) CONTENT DELIVERY IN A LOCATION-BASED MESSAGING PLATFORM

(71) Applicant: Quippy, Inc., San Jose, CA (US)

(72) Inventor: Alireza Jazayeri, San Jose, CA (US)

(21) Appl. No.: 15/640,264

(22) Filed: Jun. 30, 2017

Related U.S. Application Data
(60) Provisional application No. 62/356,530, filed on Jun. 30, 2016.
(60) Provisional application No. 62/356,531, filed on Jun. 30, 2016.
(60) Provisional application No. 62/356,532, filed on Jun. 30, 2016.
(60) Provisional application No. 62/356,533, filed on Jun. 30, 2016.

(51) Int. Cl. H04L 12/58; H04W 4/06; H04L 29/08; H04W 4/02; H04W 4/20; H04W 4/12

(52) U.S. Cl. CPC H04L 51/32; H04W 4/206; H04W 4/12; H04L 67/306; H04W 4/023; H04W 4/06

(57) ABSTRACT

A system architecture and method for delivering content from a location-based social platform. The method can include: receiving, from a client device, a request for content, the request identifying a context account of a social media platform and a corresponding client geographic location; identifying, by a computer processor, friend content broadcasted by a set of friend accounts, the set of friend accounts associated with the context account in a connection graph of the social media platform; identifying, by the computer processor, nearby content broadcasted by a set of nearby accounts, the nearby content broadcasted from geographic locations proximate to the client geographic location; merging the friend content and the nearby content to generate a result set; removing duplicative content from the result set; and providing at least a portion of the result set in response to the request.

### CROSS-REFERENCE TO RELATED APPLICATIONS

This application claims benefit of U.S. Provisional Patent Application No. 62/356,530 (attorney docket #: quippy.00001.us.p.1), filed on Jun. 30, 2016 and entitled “CONTENT DELIVERY IN A LOCATION-BASED MESSAGING PLATFORM,” U.S. Provisional Patent Application No. 62/356,531 (attorney docket #: quippy.00001.us.p.2), filed on Jun. 30, 2016 and entitled “USER DISCOVERY IN A LOCATION-BASED MESSAGING PLATFORM,” U.S. Provisional Patent Application No. 62/356,532 (attorney docket #: quippy.00001.us.p.3), filed on Jun. 30, 2016 and entitled “ARBITRARY BADGING IN A SOCIAL NETWORK,” and U.S. Provisional Patent Application No. 62/356,533 (attorney docket #: quippy.00001.us.p.4), filed on Jun. 30, 2016 and entitled “ONSITE DISPLAY IN A LOCATION-BASED MESSAGING PLATFORM.” U.S. Provisional Patent Application Nos. 62/356,530, 62/356,531, 62/356,532, and 62/356,533 are incorporated by reference herein, in their entirety.

This application is related to the following copending U.S. patent applications: (1) U.S. patent application Ser. No. ______, entitled “USER DISCOVERY IN A LOCATION-BASED MESSAGING PLATFORM,” and filed on Jun. 30, 2017, (2) U.S. patent application Ser. No. ______, entitled “ARBITRARY BADGING IN A SOCIAL NETWORK,” and filed on Jun. 30, 2017, and (3) U.S. patent application Ser. No. ______, entitled “ONSITE DISPLAY FOR A LOCATION-BASED MESSAGING PLATFORM,” and filed on Jun. 30, 2017. Copending U.S. patent application Ser. Nos. ______, ______, and ______ are incorporated by reference herein, in their entirety.

### BACKGROUND OF THE INVENTION

Hyperlocal and location-based social media platforms face unique challenges in identifying, aggregating, and delivering content. The majority of such platforms have historically targeted a consumer audience and have failed to generate the incentives necessary for a self-sustaining network effect. Many technical challenges associated with constraints of consumer clients and backend services have resulted in a lack of proliferation of location-based social platforms.

### BRIEF SUMMARY OF THE INVENTION

In general, in one aspect, the invention relates to a method for delivering content. The method includes: receiving, from a client device, a request for content, the request identifying a context account of a social media platform and a corresponding client geographic location; identifying, by a computer processor, friend content broadcasted by a set of friend accounts, the set of friend accounts associated with the context account in a connection graph of the social media platform; identifying, by the computer processor, nearby content broadcasted by a set of nearby accounts, the nearby content broadcasted from geographic locations proximate to the client geographic location; merging the friend content and the nearby content to generate a result set; removing duplicative content from the result set; and providing at least a portion of the result set in response to the request.

In general, in one aspect, the invention relates to a system for delivering content. The system includes: a computer processor; a stream module executing on the computer processor and configured to enable the computer processor to: receive, from a client device, a request for content, the request identifying a context account of a social media platform and a corresponding client geographic location; identify friend content broadcasted by a set of friend accounts, the set of friend accounts associated with the context account in a connection graph of the social media platform; identify nearby content broadcasted by a set of nearby accounts, the nearby content broadcasted from geographic locations proximate to the client geographic location; merge the friend content and the nearby content to generate a result set; remove duplicative content from the result set; and provide at least a portion of the result set in response to the request.

In general, in one aspect, the invention relates to a non-transitory computer-readable storage medium comprising instructions for providing advertising content. The instructions, when executed on at least one computer processor, enable the computer processor to: receive, from a client device, a request for content, the request identifying a context account of a social media platform and a corresponding client geographic location; identify, by the computer processor, friend content broadcasted by a set of friend accounts, the set of friend accounts associated with the context account in a connection graph of the social media platform; identify, by the computer processor, nearby content broadcasted by a set of nearby accounts, the nearby content broadcasted from geographic locations proximate to the client geographic location; merge the friend content and the nearby content to generate a result set; remove duplicative content from the result set; and provide at least a portion of the result set in response to the request.

Other aspects of the invention will be apparent from the following description and the appended claims.

### BRIEF DESCRIPTION OF THE DRAWINGS

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

Embodiments of the present invention are illustrated by way of example, and not by way of limitation, in the figures of the accompanying drawings and in which like reference numerals refer to similar elements.

FIGS. 1A and 1B show schematic diagrams of systems, in accordance with one or more embodiments of the invention.

FIGS. 2A-2C depict example user interfaces showing friends-only and merged (friends+nearby) streams, in accordance with one or more embodiments of the invention.

FIG. 3 depicts an example user interface displaying users nearby, in accordance with one or more embodiments of the invention.

FIGS. 4A and 4B depict example user interfaces displaying creation of a new hangout, in accordance with one or more embodiments of the invention.

FIGS. 5A and 5B depict example user interfaces displaying hangouts and users in a nearby view, in accordance with one or more embodiments of the invention. Functionality such as chat can be enabled based on social or distance proximity, as displayed.

FIGS. 6A and 6B depict example user interfaces displaying a hangout in a location-based social media stream, in accordance with one or more embodiments of the invention.

FIGS. 7A and 7B depict example user interfaces displaying hangouts in a user's social network (7A) and hangouts nearby (7B), in accordance with one or more embodiments of the invention.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

In general, embodiments of the invention provide methods and systems related to location-based social networking systems and architecture.

Merged Stream

Assumptions: It turns out that the assumption is often not true that users are interested in connecting solely with strangers when they're at a particular location. Many failed attempts were made based on this assumption. Many people want to have interactions/engagement/conversations with people in their social network. Further, they want that conversation to be public. Location is a factor.

Merged Stream: Created a feed/stream of content that is a combination of these two things. Specifically, two modes that can be merged, friend content and (geographically) nearby content. Can present the content in reverse chronological order (or other order based on performance of the content items) and remove duplicates because a particular content item may be in both categories.

Friend content: Content from (or related to) your friends. May have nothing to do with proximity or location, may show in a context account's feed regardless of geographic proximity.

Nearby content: Content from (or related to) nearby users.

Density-Based Geohashing

One approach is to determine what content is near a requesting user, realtime, everytime. That's a lot of computation. On a large scale, it could take a platform a long time (e.g., 3 hours) to respond to a request.

Geohashing involves logically dividing an area (e.g., the surface of the Earth) into a checkerboard, using an alphanumberic hash. Related geohash regions can be quickly found using the alphanumberic hash values. Density-based geohashing involves making the checkerboard squares into smaller squares (or whatever relevant shape) as the density of content increases.

We apply density-based geohashing in a new ways (e.g., choosing nearby content, discovering users, etc.). So the benefit is that we solve two different problems: (1) the calculation is lightning fast and may happen even before a related request, thereby performance, speed, and efficiency is increased. (2) we have a built in automatically-adjusting range, so we can serve content in meaningful arrangements.

For example, say North America is one square (or “bucket”). If that bucket becomes overflowed beyond 100 content items, it breaks into 10 buckets (or 32 buckets, etc). Then if any of those buckets are overflowed, they break into further buckets. Each bucket therefore provides a fixed number of content (or at least a maximum ceiling). So if you're in Manhattan, and there are a million posts per second around you, it's okay because you'll be in the bucket of (let's say) just this block, so you're not overwhelmed. And the nearby content is likely more interesting to you versus content from a mile away. But if you're in a low density area like Alaska, your bucket may be geographically larger, so you'll get a similar amount of content and it'll likely be interesting to you.

We may grab a number of (e.g., 8) adjacent geohash regions (above, below, sides, etc.).

We use geohashing for live user discovery as well (determining which users are nearby the user). Eg, how what is defined as nearby? That's different in Kansas vs NY.

Edge cases had to be solved: What if nothing in your region? What if you're in a bucket of only 1 content item? Etc.

Promoted Content

We can insert promoted content into choice buckets (or geohash tree) and the promoted content will be naturally fanned out to the users. We can choose which bucket we want to insert it into. This is an approach with high control and targeting. For example, accordingly, we can tell you how many people it will reach. As opposed to a radius approach where we're not entirely sure how many people will be reached.

User Onboarding: We can immediately have content ready for new users because those users will start in an existing bucket. That bucket will already have content items “in” it.

Stream Dynamics

This can apply to both merged (friend content+nearby content) or unmerged streams.

Due to performance, bandwidth, and/or design consistency constraints, it can be difficult to maintain a smooth user experience (scrolling, playback, consistent design, etc.) in a content stream with long duration videos/photos and/or different aspect ratios.

Story style consumption experiences only show you one content item at a time, stream style consumption experiences show you multiple content items at a time. We show you a content stream style consumption experience, but we show you stream of constrained previews of content items to overcome any potential constraints (e.g., performance, bandwidth, etc.).

For example, when a user is uploading content, we provide the user with an opportunity to choose a preview portion of the content. For example, for photos, the user can choose a square aspect ratio portion of the photo to be the preview. We will use that preview in other user's streams. When another user selects (or otherwise shows interest in) the preview in their stream, we can then provide the full version to that user (e.g., perhaps even full screen). Similar functionality with video (choose a square area of the video). With video, we can enforce a duration limit on the preview (e.g., 10 seconds maximum). We can also automatically choose the preview portion without a user selection. Note that the preview aspect ratio is not limited to square, but other aspect ratios (e.g., rectangular).

Hot Spots

Hot spotting can be done by one of three “top-down” approaches:

Geo-fencing: Pay someone to go map some place, divide that map into public regions and private regions. Anything posted in public region we'll surface, anything posted in private we won't surfaced. Very difficult to map every school etc.

Publicly Available API: Let google indicate what is public or private. Eg anything near Oracle arena, surface as an event. But Oracle Arena is Warriors one night but then Justin Bieber the next night. So the event is always just “Oracle Arena”, not dynamically “Spurs vs Warriors” or “Justin Bieber Purpose World Tour”.

Manual Curation: Hand pick content to provide (eg Snapchat stories). Human driven, slow, not scalable.

Our platform uses a “bottom-up” approach: Clustering to dynamically/realtime generate/discover events.

A New Approach

We cluster the postings (based on different factors) to determine that an event is happening. We may globally check for clusters with some frequency (e.g., every 10 min). For example, say your friends decide to party in the street, like the Saratoga street party. That's not a place like Oracle Arena, but still an entity worth capturing. Geohashing. What if an event falls across two regions? We overlap every region on every edge, so such an event will appear in both regions. If there are resulting duplicates if/when we merge the result sets, we remove the duplicates.

We assign each event a hot spot rating. Rating criteria can be based on the amount of content and the recency of content. And will consider each of the two criterion to decide what to show (something might be close but not high amount). For example, how many postings there are about the street dance and how recently they were posted.

Upon receiving an app's request for events, we decide whether we should serve a cluster to that user. Could be based on cluster rating (e.g., amount and recency) and proximity to requesting user.

Private content is excluded. We don't use private content for the clustering, we only use public content. Private data can be anything broadcasted but marked as for friends only, or direct messages which are inherently private. However, we can weave in private data to the cluster.

For an ephemeral platform, after an amount of time (e.g., 2 weeks) we remove everything (it's actually archived, but users don't see).

Content Flooding

Flooding: Flooding can occur when someone you follow posts frequently/repeatedly/incessantly, thereby flooding your stream and elbowing out other content. So flooding is not necessarily spam from 3^{rd} parties. But 3^{rd} party spam is addressed by these embodiments as well. We may have a bigger flooding problem than other social networks because the flooders here are your friends. Even more, here strangers can flood because they can get into any nearby user's feed.

Various Solution Embodiments

Rate limiting—Limit how much a person can post. This is a common solution.

Content collapsing—Someone posts 5 items. We decide to group the most recent 3 items (or some other number), and on the third item we provide a user interface element (e.g., a “see more” button) to see the other 2 items.

Upon activation of the see more button, could provide/display the additional items in various ways. For example, unfold such that additional items are shown in that same stream display. Or navigate to new page showing just those additional items. Or a carousel display of the items. Etc.

There doesn't necessarily have to be a user interface element the activation of which causing more items to show. For example, we could infer from a user's viewing time of the initially displayed items that they are interested in additional items.

The initially displayed items don't necessarily have to be the most recent. For example, we could choose the items with highest engagement.

Pagination: When app requests content, the server will provide content with pagination (e.g., returns the first 30 items until the client asks for the next 30 items). We can choose which content to be collapsed based on the pagination. So if a flooding user posts 15 items where the first 10 items would have appeared on the first page and the next 5 items would have appeared on the second page: on the first page the first 3 items are shown with the next 7 items collapsed, then on the next page items 11-13 are shown with items 14-15 collapsed. Because the collapse of the 7 items of the first page may cause a void, other items that would have otherwise been on the next page may be moved to the first page instead.

Figure: An “aerial” view showing the context account's device in the center. Also showing other accounts' device scattered throughout at varying distances. Showing in a caption bubble that each account has made a post (maybe multiple posts in 1-2 instances) with associated timestamps. Usually concentric circles could be used to show distance bands that these devices fall into, but here we can overlay geohash regions. For example, maybe a big one (North Bay Marin area where there are fewer users) next to 3 small ones (San Francisco, where there are more users). Some of these accounts are friends and others are not, can use this to help demonstrate that friend posts always make it into the timeline regardless of distance/geohash region, while non-friend posts only make it into the timeline if proximate enough.

Figure: A timeline screenshot showing a mix of friend posts and nearby posts, probably corresponding to the friend/non-friend accounts shown above. Could illustrate the duplicate situation of a friend posting nearby, so show one message making it into the timeline and the duplicate laterally positioned outside the timeline and dotted to indicate it was omitted.

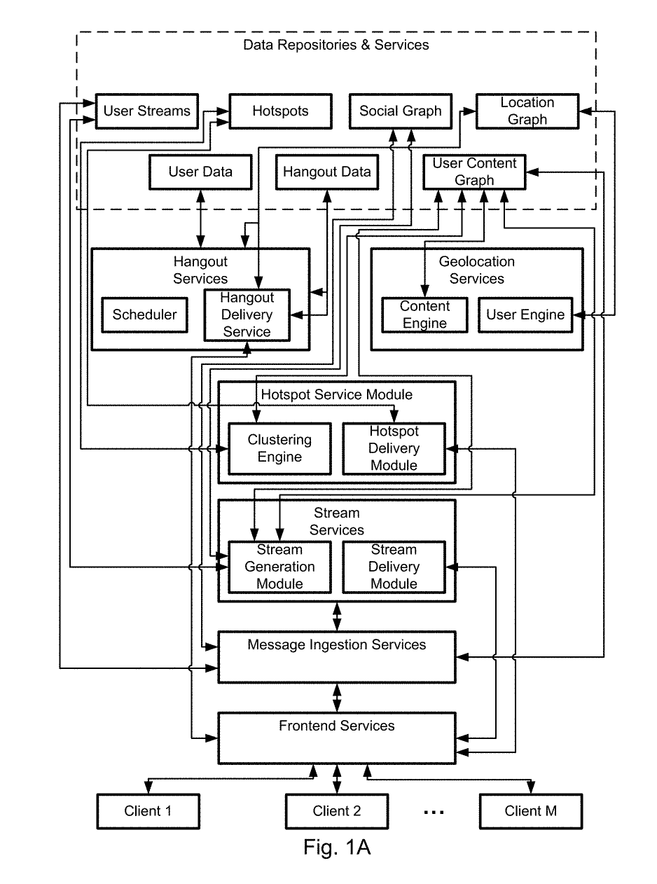

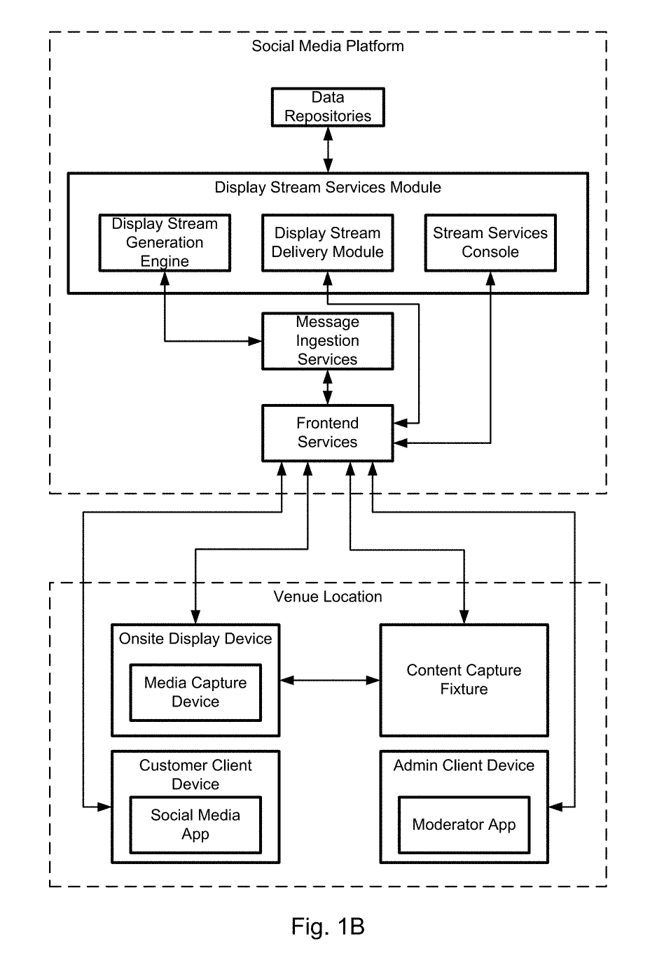

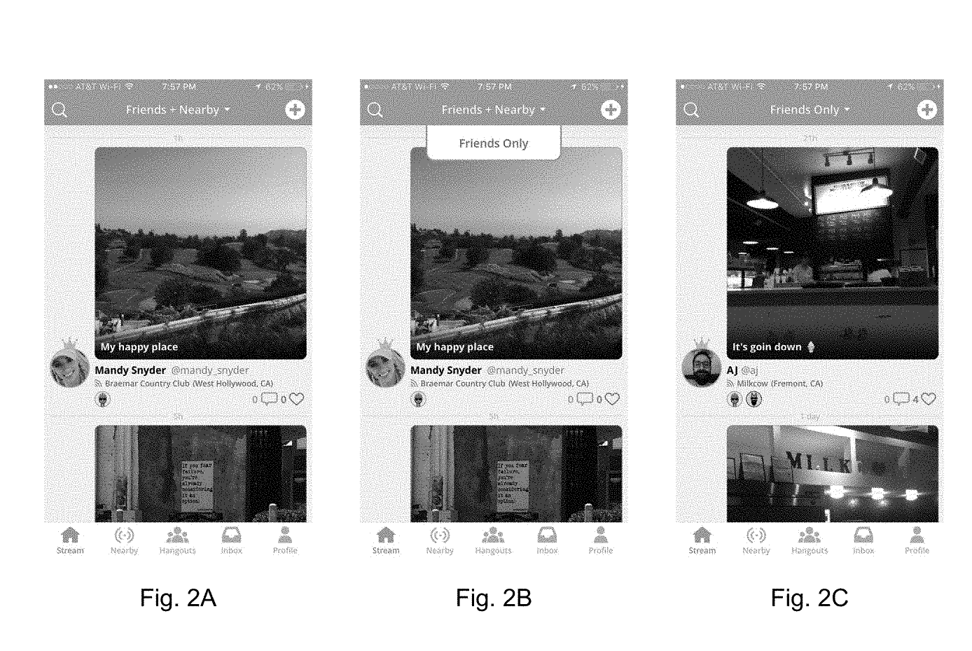

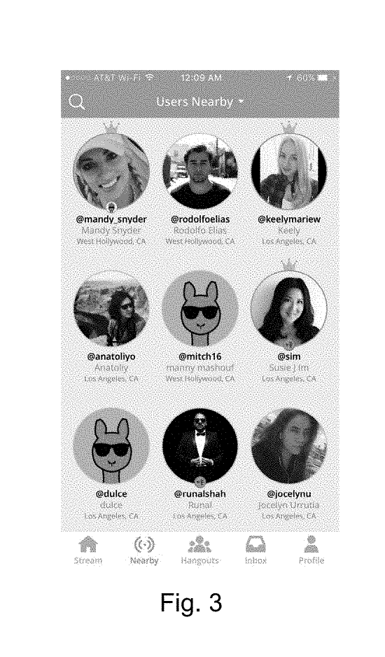

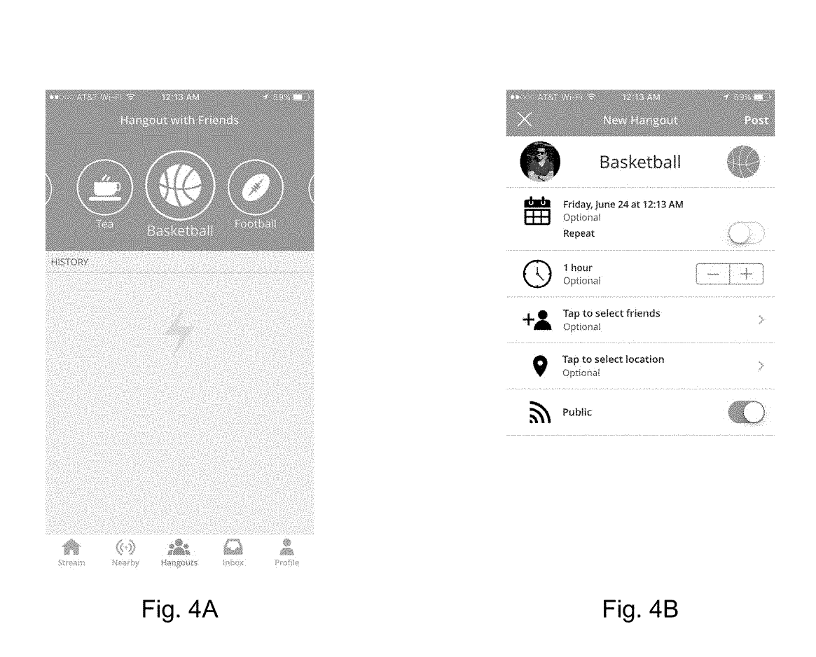

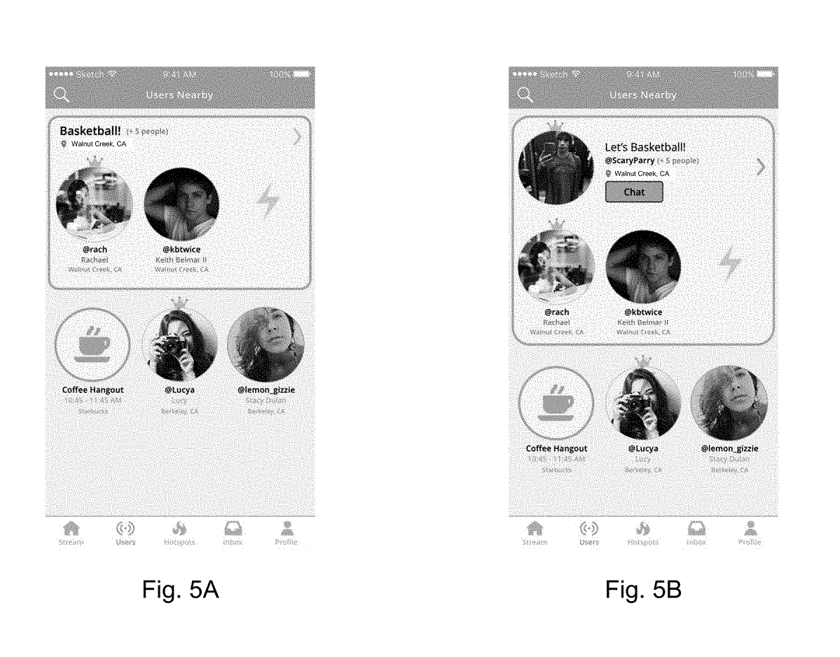

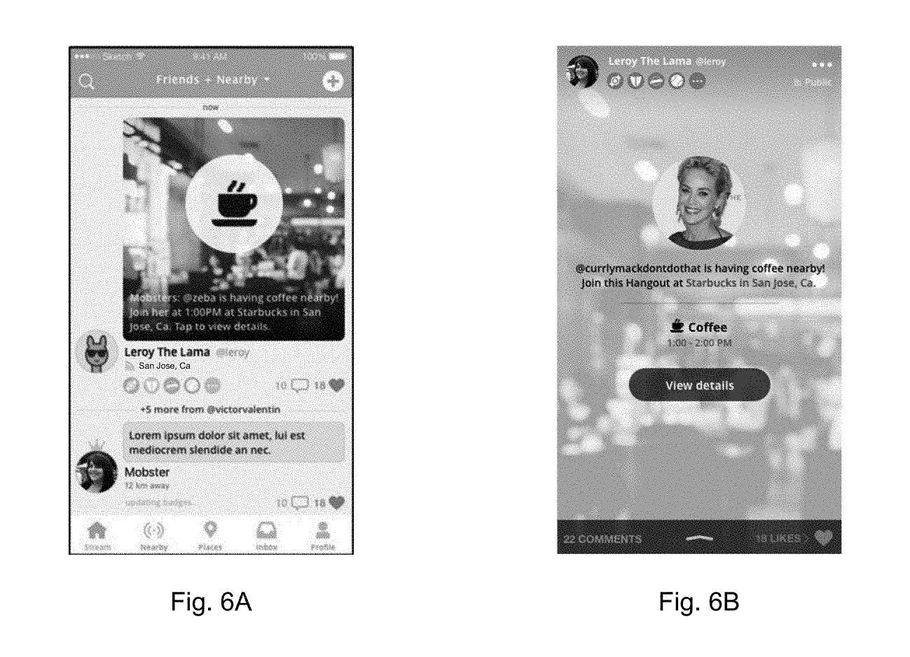

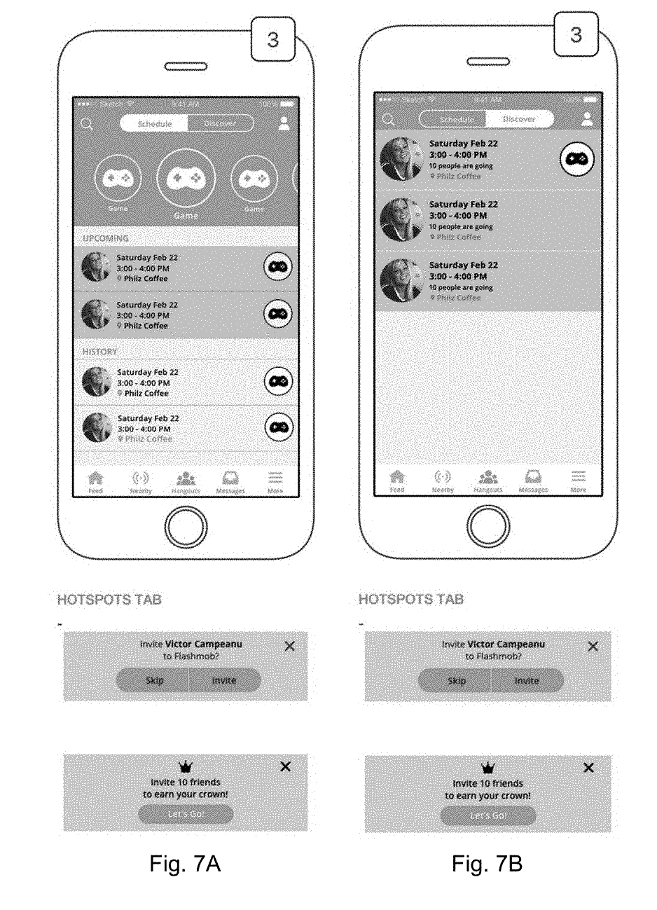

Re FIG. 1A:

1) User Streams: this is a repository that includes a data structure representing a stream of data for each user. This stream includes only data from friends and followed accounts initially. The Message Ingestion Service copies each message that is posted by a user into their followers/friends streams as they are posted. This is how the streams are updated in realtime as messages are “ingested” by the system. Nearby data is not added to the stream until it is requested by a user. In other words, if a user client requests their stream the Stream Generation Module fetches it from the User Streams Repo and then merges it with nearby data from the User Content Graph in realtime, then serves the merged data to the user client.

2) The clustering Engine: a distributed offline service that takes user content from the User Content Graph and groups that data into Hotspots. These hotspots, which are the output of the clustering process are stored in the Hotspots Repo.

The clustering engine begins by segmenting the clustering work geographically. Since the data in the User Content Graph is stored in a density-based geohash tree structure, the Clustering Engine can select leaf nodes of the tree (or select a fixed number of hops above the leaf nodes) in order to grab a quasi-fixed size chunk of data from a variable sized geographic region.

So some regions may be dramatically different in geographic size, but should represent some upper bound in terms of content size (i.e., number of content items).

Let's call the selected region R. The next thing that the Clustering Engine does is to grab leaf nodes of the density based geohash tree that cover the perimeter of region R.

These surrounding regions may also be of variable geographic size

Let's call the resulting region F=R (selected region)+N (neighboring regions). This resulting region F is passed to a worker service of an elastic computing cluster for analysis.

So the initial identification of the multiple F regions happens by a Master Clustering Service which then passes the F regions to multiple worker services. Each worker service performs the actual clustering on its respective region. The clustering we perform is fixed-radius clustering, but any type of clustering algorithm may be used. For example, K-means clustering or other types of clustering may be performed. Fixed radius clustering is preferred because it represents variable number of clusters of fixed (or semi-fixed) geographic size.

Once each worker completes clustering it returns the result of the clustering (a set of identified clusters) to the Master Clustering Service (MCS). The MCS the obtains the results from each worker and performs a deduplication. Deduplication means that if there are any 2 clusters that overlap, we delete the one with the lower density. Deduplication is necessary because the regions were deliberately selected to overlap, in order to prevent edge cases where a cluster overlaps two workers' regions. Since the regions overlap (by virtue of the fact that we selected perimeter neighbors), the cluster will be identified by at least 1 of the workers in full.

The MCS then stores the deduplicated results in the Hotspots Repo.

Again, the Clustering Engine includes the MCS and the workers, which are implemented in an elastic computing cluster.

The clustering engine performs the clustering and overwrites the data in the Hotspots repo periodically (eg, every 5 minutes). This way the clusters stay current and the data that is posted by users makes it into a cluster within at most 5 minutes of time (+clustering runtime).

The Hotspot Delivery module (HDM) obtains requests from clients, each request including a location of the client. The HDM then fetches a set of the hotspots from the Hotspot Repo that are closest to the client location. The Hotspots in the Hotspot Repo are also stored by their geohash value, and are also stored in a density-based geohash tree. This way, we can fetch hotspots only in the leaf node region of the tree (plus neighbors), order them by proximity to the client, and return a predefined number of them in response to the request.

3) The Social Graph Repo: this stores the relationships (both bi-directional and directed edges) between accounts. These represent followers, friends, or other types of relationships. This data is used by the Message Ingestions Service to create and store the streams (connect that edge also MIS<->Social Graph).

4) User Data simply stores the name, display name, and other account attributes of each user. Even though not shown, this data is used by most of the services of FIG. 1A.

5) Hangout Data Repo: this stores the details of each Hangout created by our users. Again, there may be other data repos within this repository that include necessary Hangout data.

6) Hangout Services: this is a collection of services that schedules, creates, modifies, and delivers hangouts in response to user requests. This includes a Scheduler which schedules Hangouts and generates notifications when users are invited, join, leave otherwise interact with hangouts.

Hangout Delivery Module fetches hangout information from both the Location Graph and the Hangout Data Repo and returns that data in response to client requests.

7) Location Graph Repo: this is one of the most important repositories in the system. This Repo stores objects representing the location of physical entities in a density based geohash tree structure. An object in the Location Graph can include: a user object representing the last known location of a user, a hangout object representing the location of a hangout, a venue object representing the location of a physical location (eg, a business, an event) and etc.

Each object can also include an effective date/time/duration representing when it is active. For example, once a hangout is over it would no longer be active.

Or, the timeouts for user objects would dictate how or when they are surfaced to other users (as described in the “live user discovery” algorithms).

Geolocation Services Module may periodically prune/remove stale data from the Location Graph Repo as desired.

Next topic will be how Hangout, user, and venue objects are stored in the Location Graph Repo and why that data needs to be duplicated.

So, let's start with user data in the Location Graph Repo. The Flashmob app on the user device has a background location monitoring engine (BGE) that uses the operating system API to track the user's location even when they aren't using the app. In iOS there are two methods of doing this: one is called significant location change and the other is region monitoring. Either can be used. The premise is that the BGE tracks the user's location and sends updates of the location to the Frontend Service which then relays the updates to the Geolocation Services Module. There is an object representing the user in the Location Graph Repo, and the User Engine of the Geolocation Services Module updates that user's location in the Repo. This location is stored as a geohash value. There is a Geohash Tree Engine (GTE) that is not shown, which balances all of the geohash trees and handles insertion, removal, and update of content in the tree. If the new geohash value changes from one leaf node of the density-based geohash tree to a different leaf node, the GTE performs a rebalance of the tree. The GTE performs this rebalance by basically leaving the old user object but marking it for removal (inactive) and just adding a new user object with the new geohash value. There is a periodic process which essentially “rebuilds” the geohash tree and prunes the old geohash values. In an alternate implementation, a recursive algorithm restructures the tree on-demand to maintain balance.

This maintenance of the density-based geohash tree (DBG tree), along with the GTE applies to all DBG trees in the system including the User Content Graph, and the Hotspots DBG tree in the Hotspots repo.

(although the Hotspots do not typically require insertion and removal with the exception of manual curation by and administrator, removal of NSFW content, regional blacklisting, etc)

Hangout objects in the Location Graph Repo are similarly stored. There are different consumption experiences in the client application that require different usages of this Repo. The main ones are: Nearby User Discovery, Hangouts Discovery, Venue Discovery, and hybrids of one or more of them. The term “live user discovery” can refer to any of the aforementioned and is not strictly limited to user objects. So, in nearby user discovery for example, the Geolocation Services Module gets a request to fetch nearby users for a client. The location of the client is used to identify a search region R (including perimeter neighbors), all active users in R are ordered by proximity to the client, and the closest X users (depending on requested page size) are returned to the client in response to the client request.

In the hybrid approach, a single view in the client application can display any of the three object types in the same result set, ordered by proximity to the client.

One important point about the DBG trees is that they include replicated data (for performance reasons). In other words, each DBG tree node includes all data required for its respective consumption experience. For example, user objects include username, display name, profile thumbnail URL, and a subset of other user attribute data that is already stored in the User Data Repo. Updates to the User Data Repo must therefore also be made to the Location Graph Repo and vice versa to maintain consistency. In this way, a single query to the Location Graph Repo can quickly fetch results with no external dependency.

Server

Clustering algorithm, one embodiment showing pseudocode of the base implementation:

Function frnn(D, radius)
1. Pick a point at random, call it p
2. Let the initial set of clusters be the set which contains only the one
point cluster {p}. That is, let Clusters = { {p} }
3. For every x in D do
a. For every C in Clusters calculate the proximity of x to C
b. If promity of x is greater than radius for every C in Clusters then add
a new one point cluster {x} to Clusters.
c. Otherwise find the cluster C such that proximity(x, C) is minimal and
add x to that cluster.
Lastly, return Clusters

Parameter Selection: (i) Select a minimum depth of Min=3 for adjacency grouping, ie, we only select adjacent geohashes for regions that have at least a depth of 3. Any leaf nodes above the Min depth would still be clustered but without including adjacent neighbors. Min depth prevents selecting adjacent geohashes for regions that are too large. (ii) Select a Max depth of 4. Max depth defines the most granular region for clustering.

Algorithm: (Step 1) Identify the set of unique geohash values in the database as set G. (Step 2) Select an unmarked geohash value from G as a cluster region. (Step 3a) If the cluster region is lower than depth 4 (Max), truncate the region's geohash to expand the cluster region to a depth of 4. (Step 3b) If the cluster region is at least at depth 3, expand the cluster region to include adjacent perimeter geohashes (eg, P1 . . . P8). There may be any number of adjacent geohashes depending on the depth of the tree at those areas. (Step 4) This resulting cluster region is R. Tag all posts that are in the final cluster region (R). Go to step 2. (Step 5) Cluster the points in each of the regions R in parallel. For each identified cluster, store the 6-digit geohash value (V) of the centroid of the cluster (easy to calculate from the lat/long of the centroid). (Step 6) Take the resulting clusters and deduplicate them. One or more steps can be performed concurrently in accordance with various embodiments (for algorithms and methods depicted in this disclosure).

Deduplication algorithm: (Step 1) Select an unmarked cluster C (Step 2) Create a comparison set S that includes: (Step 2a) all clusters having a matching 6-digit geohash value (V) to C (Step 2b) all clusters in any one of the 8 neighboring regions to V (Step 3) Compare each cluster in the comparison set S to every other cluster in S. For any two clusters that have a centroid within 500 meters of one another, delete the lower density cluster. Mark all remaining clusters in S. Proceed to step 1. Alternately, we can simply compare geohash values of the centroids to identify overlapping clusters (ie, compare geohashes with sufficient geohash similarity to know they are within X distance). One or more steps can be performed concurrently in accordance with various embodiments.

Geohash Tree: (Step 1) Construct density-based geohash tree with density threshold=50, max depth of tree=9 (example values). (Step 2) Ingest newly posted messages into tree immediately upon posting (by spawning threads on-demand)

Removal of Posts from the Tree (Periodic Batch Process):

(Step 1) Flag all posts older than 24 hours for removal from the tree. When a user wants to delete a post, it should be flagged in the same manner. This way the next batch process will remove it from the tree.

(Step 2) Select a flagged post. If none exist, end. Also select the following: (Step 2a) all flagged posts that have the same geohash. (Step 2b) all flagged posts that have the same parent (must be same length geohash).

(Step 3) Identify the parent of the selected posts from step (2) (all must have the same parent). Check the database for ANY posts having this parent which also have a longer geohash string than the selected posts (number of characters). If any posts are found with a longer geohash string, delete all of the selected posts (from step 2) and continue to step 2. Else continue to step 4.

(Step 4) Count the selected posts to get a removal count (R). Find the number (N) of all non-selected posts having (i) same length geohash string and (ii) same parent as the selected posts. If (N−R) is less than the geohash max node threshold (in our example 50) truncate a digit from the geohash of all non-selected posts counted in N. Delete the selected posts and proceed to step 2. One or more steps can be performed concurrently in accordance with various embodiments.

Feed Algorithm:

Separate Endpoints for Pull-to-Refresh and Auto-Refresh:

Pull-to-Refresh (PTR)

Part 1: Identifying the Search Region(s)

(Step 1) Receive a client request with a stream location (S)

(Step 2) Identify the geohash of the leaf node containing S. If the leaf node includes >50 posts (ie, it is a lowest level leaf of the tree with more than 50 posts), select the leaf node as N. Else, step up one level and select the parent node as N (sanity check: make sure the parent has at least 20 points).

(Step 3) Identify 8 perimeter geohash values (P1 . . . P8) for regions surrounding N.

(Step 4) Within each of P1 . . . P8, select leaf nodes of the tree which (i) are adjacent to perimeter of N and (ii) have at least one content item

(Step 5) The resulting selected leaf nodes+N comprise the global search region (R) for the query. One or more steps can be performed concurrently in accordance with various embodiments.

Part 2: Producing a Result Set

(Step 1) Score and rank all posts in the search region R using Score=A+0.69*B, where A is distance (meters) of the post from the stream location and B=age of post (seconds). Before scoring, ignore any posts in Z={posts already seen by the client} and Y={posts by blocked/muted users}.

(Step 2) Return the 30 highest ranking posts. One or more steps can be performed concurrently in accordance with various embodiments.

Notes: The entire messages repository (and Z) are pruned periodically to remove items older than 12 hours

Auto-Refresh

In one embodiment, for auto-refresh the system fetches up to 30 nearest posts, only from nearby users (eg, <500 m).

Client

Auto-refresh: In one embodiment, only perform auto-refresh if the scroll area is within 5 messages of the most recent (top-most) message

For purposes of this disclosure, the terms messaging platform, social media platform, and social network may be used interchangeably.

Various system configurations: Although the components of the systems are depicted as being directly communicatively coupled to one another, this is not necessarily the case. For example, one or more of the components of the systems may be communicatively coupled via a distributed computing system, a cloud computing system, or a networked computer system communicating via the Internet.

Various system configurations: It should be appreciated that one computer system may represent many computer systems, arranged in a central or distributed fashion. For example, such computer systems may be organized as a central cloud and/or may be distributed geographically or logically to edges of a system such as a content delivery network or other arrangement. It is understood that virtually any number of intermediary networking devices, such as switches, routers, servers, etc., may be used to facilitate communication.

While the present disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. Some of the steps may be performed simultaneously. For example, in certain circumstances, multitasking and parallel processing may be advantageous. The various example methods described and/or illustrated herein may also omit one or more of the steps described or illustrated herein or include additional steps in addition to those disclosed.

Embodiments may be implemented on a specialized computer system. The specialized computing system can include one or more modified mobile devices (e.g., laptop computer, smart phone, personal digital assistant, tablet computer, or other mobile device), desktop computers, servers, blades in a server chassis, or any other type of computing device(s) that include at least the minimum processing power, memory, and input and output device(s) to perform one or more embodiments.

For example, a computing system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), a bus, and numerous other elements and functionalities. The computer processor(s) may be an integrated circuit for processing instructions. For example, the computer processor(s) may be one or more cores or micro-cores of a processor.

In one or more embodiments, the computer processor(s) may be an integrated circuit for processing instructions. For example, the computer processor(s) may be one or more cores or micro-cores of a processor. The computer processor(s) can implement/execute software modules stored by computing system, such as module(s) stored in memory or module(s) stored in storage. For example, one or more of the modules described in the figures can be stored in memory or storage, where they can be accessed and processed by the computer processor. In one or more embodiments, the computer processor(s) can be a special-purpose processor where software instructions are incorporated into the actual processor design.

The computing system may also include one or more input device(s), such as a touchscreen, keyboard, mouse, microphone, touchpad, electronic pen, or any other type of input device. Further, the computing system may include one or more output device(s), such as a screen (e.g., a liquid crystal display (LCD), a plasma display, touchscreen, cathode ray tube (CRT) monitor, projector, or other display device), a printer, external storage, or any other output device. The computing system may be connected to a network (e.g., a local area network (LAN), a wide area network (WAN) such as the Internet, mobile network, or any other type of network) via a network interface connection. The input and output device(s) may be locally or remotely connected (e.g., via the network) to the computer processor(s), memory, and storage device(s).

One or more elements of the aforementioned computing system may be located at a remote location and connected to the other elements over a network. Further, embodiments may be implemented on a distributed system having a plurality of nodes, where each portion may be located on a subset of nodes within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

For example, one or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface.

One or more elements of the above-described systems may also be implemented using software modules that perform certain tasks. These software modules may include script, batch, routines, programs, objects, components, data structures, or other executable files that may be stored on a computer-readable storage medium or in a computing system. These software modules may configure a computing system to perform one or more of the example embodiments disclosed herein. The functionality of the software modules may be combined or distributed as desired in various embodiments. The computer readable program code can be stored, temporarily or permanently, on one or more non-transitory computer readable storage media. The non-transitory computer readable storage media are executable by one or more computer processors to perform the functionality of one or more components of the above-described systems and/or flowcharts. Examples of non-transitory computer-readable media can include, but are not limited to, compact discs (CDs), flash memory, solid state drives, random access memory (RAM), read only memory (ROM), electrically erasable programmable ROM (EEPROM), digital versatile disks (DVDs) or other optical storage, and any other computer-readable media excluding transitory, propagating signals.

It is understood that a “set” can include one or more elements. It is also understood that a “subset” of the set may be a set of which all the elements are contained in the set. In other words, the subset can include fewer elements than the set or all the elements of the set (i.e., the subset can be the same as the set).

While the invention has been described with respect to a limited number of embodiments, those skilled in the art, having benefit of this disclosure, will appreciate that other embodiments may be devised that do not depart from the scope of the invention as disclosed herein.

Hot Spots Embodiments

S1. A system for delivering event notifications, comprising: a computer processor; a clustering module executing on the computer processor and configured to enable the computer processor to: identify a density-based geohash region corresponding to a target geographic location; determine associations between a subset of content of the geohash region; group the subset of content of the geohash region to generate an event; receive a request for event notifications, the request identifying a context account of a social media platform and a corresponding client device geographic location; determine that the client device geographic location is proximate to the target geographic location and related to the density-based geohash region; and provide the event in response to the request.

M1. A method for delivering event notifications, comprising: identifying, by a computer processor, a density-based geohash region corresponding to a target geographic location; determining associations between a subset of content of the geohash region; grouping, by a computer processor, the subset of content of the geohash region to generate an event; receiving, from a client device, a request for event notifications, the request identifying a context account of a social media platform and a corresponding client device geographic location; determining, by a computer processor, that the client device geographic location is proximate to the target geographic location and related to the density-based geohash region; and providing the event in response to the request.

M2. The method of claim M1, wherein determining associations comprises: a fixed-radius geo-clustering algorithm

M3. The method of claim M1, further comprising: identifying a set of geohash regions proximate to the current geohash region; determining associations between a subset of content of the current geohash region and content of the set of geohash regions; and grouping the subset of content of the current geohash region and the subset of content of the set of geohash regions to generate the event.

M4. The method of claim M1, further comprising: determining additional associations between additional subsets of content of the current geohash region; grouping the additional subsets of content of the current geohash region to generate a set of events, wherein the set of events includes the event; ranking the set of events according to ranking criteria, wherein the ranking criteria is used to rank the set of events based on a count of content for each event, and a broadcasting recency of content for each event; and providing a highest ranked subset of the events.

M5. The method of claim M1, further comprising: providing content associated with the event, wherein private content is not provided unless broadcasted by a friend account of the context account.

M6. The method of claim M1, further comprising: removing duplicative content from the event result set.

Figures (Hot Spots)

Figure: Again, a similar “aerial” view discussed above, including geohash regions with various friend/non-friend account posting locations, caption bubbles, and timestamps. Overlay dotted circles (or jagged shapes) denoting where we've inferred the existence of an event. In the spec, explain that some of these posts are related based on content, temporal, and geographic proximity.

Figure: A timeline stream or map as it might be displayed on a client device?

(Content Flooding)

A1. A method for delivering messages, comprising: receiving, from a client device, a request for messages, the request identifying a context account of a social media platform; identifying a set of messages to provide in response to the request; determining that a group of the messages are related; determining that a displaying of the set of messages in reverse chronological order would cause the group of related messages to exceed a related message display threshold; selecting a subset of the group of related messages for display; removing a remainder of the group of related messages from the set of messages to avoid exceeding the threshold; and providing, in response to the request, the set of messages with an indication of the selected related messages and a reference to the remainder of related messages.

A2. The method of claim 1, wherein determining that a group of messages are related is based on a common author, based on a common topic, and/or based on common content (etc.?).

A3. The method of claim 1, wherein the threshold is based on temporal proximity of the related messages to one another, spacial proximity of the related messages to one another (meaning if there are unrelated intervening messages or not, there's probably a better word than spacial but can define it in the spec so that the reader knows what we mean), and/or a count of the related messages.

A4. The method of claim 1, further comprising determining a subset of the messages to be displayed on a first page; and wherein the determining that a displaying of the set of messages would cause the group of related messages to exceed a related message display threshold is limited to the subset of messages. (pagination)

B1. A method for displaying a message timeline, comprising: receiving, at a client device, a set of messages with an indication of selected related messages and a reference to a remainder of related messages; displaying, on a first page, the set of messages in reverse chronological order, wherein: the selected related messages are displayed adjacent to one another, and the reference to the remainder of related messages is displayed adjacent to the selected related messages.

B2. The method of claim 1, further comprising: receiving an activation command corresponding to the reference; and in response to the command, displaying at least a portion of the remainder of related messages.

Figures (Content Flooding)

Figure: User interface figure showing a traditional timeline where the flooding would go unchecked. Then our user interface showing that (1) the related posts are grouped together and (2) the excess posts are not displayed but instead replaced with an indicator of their existence. Then another figure showing what happens if the user activates the indicator, ie, that the excess posts are shown. Probably can have more than one version of this figure because it can expand in place like an accordion, be like a carousel, take the user to a new page focused on the excess posts, etc.

What is claimed is:

1. A method for delivering content, comprising:
receiving, from a client device, a request for content, the request identifying a context account of a social media platform and a corresponding client geographic location;
identifying, by a computer processor, friend content broadcasted by a set of friend accounts, the set of friend accounts associated with the context account in a connection graph of the social media platform;
identifying, by the computer processor, nearby content broadcasted by a set of nearby accounts, the nearby content broadcasted from geographic locations proximate to the client geographic location;
merging the friend content and the nearby content to generate a result set;
removing duplicative content from the result set; and
providing at least a portion of the result set in response to the request.

2. The method of claim 1, wherein identifying nearby content comprises:
accessing a content repository, wherein the content repository organizes content according to density-based geohashing regions;
identifying a current geohash region corresponding to the client geographic location and a set of geohash regions proximate to the current geohash region; and
identifying the nearby content from the current geohash region and the set of geohash regions.

3. The method of claim 2, further comprising adding promoted content to a subset of the geohash regions.

4. The method of claim 2, wherein identifying the nearby content further comprises:
detecting a set of geohash values corresponding to the geohash search region;
calculating a geohash search region using the geohash values; and
searching the geohash search region to identify the nearby content.

5. The method of claim 4, further comprising:
constructing a density-based geohash tree using the set of geohash values, wherein each of the set of geohash values comprises a character length corresponding to a density of content in a geographic region.

6. The method of claim 3, wherein the request comprises a timestamp, and wherein identifying the friend content further comprises:
identifying a friend queue corresponding to each of a plurality of user accounts; and
obtaining the friend content from the friend queues based on the timestamp.

7. The method of claim 1, further comprising:
ranking content of the result set according to ranking criteria, wherein the ranking criteria is used to rank the content based on an engagement history between the context account and the set of friend accounts, a geographic proximity of the nearby content, a popularity score of the friend accounts and nearby accounts; and
providing a highest ranked portion of the result set.

8. The method of claim 1, wherein providing the at least a portion of the result set comprises:
providing a set of constrained preview content items for constrained display in a stream view on the client device, wherein selection of a constrained preview content item by a user causes a second request for a corresponding full content item; and
providing the corresponding full content item in response to the second request.

9. A system for delivering content, comprising:
a computer processor;
a stream module executing on the computer processor and configured to enable the computer processor to:
receive, from a client device, a request for content, the request identifying a context account of a social media platform and a corresponding client geographic location;
identify friend content broadcasted by a set of friend accounts, the set of friend accounts associated with the context account in a connection graph of the social media platform;
identify nearby content broadcasted by a set of nearby accounts, the nearby content broadcasted from geographic locations proximate to the client geographic location;
merge the friend content and the nearby content to generate a result set;
remove duplicative content from the result set; and
provide at least a portion of the result set in response to the request.

10. The system of claim 9, wherein the stream module is further configured to:
access a content repository, wherein the content repository organizes content according to density-based geohashing regions;
and a geohash module configured to:
identify a current geohash region corresponding to the client geographic location and a set of geohash regions proximate to the current geohash region; and
identify the nearby content from the current geohash region and the set of geohash regions.

11. The system of claim 10, wherein the stream module is further configured to: add promoted content to a subset of the geohash regions.

12. The method of claim 10, wherein identifying the nearby content further comprises:
detecting a set of geohash values corresponding to the geohash search region;
calculating a geohash search region using the geohash values; and
searching the geohash search region to identify the nearby content.

13. The method of claim 12, wherein the geohashing module is configured to:
construct a density-based geohash tree using the set of geohash values, wherein each of the set of geohash values comprises a character length corresponding to a density of content in a geographic region.

14. A non-transitory computer-readable storage medium comprising instructions for providing advertising content. The instructions, when executed on at least one computer processor, enable the computer processor to:
receive, from a client device, a request for content, the request identifying a context account of a social media platform and a corresponding client geographic location;
identify, by the computer processor, friend content broadcasted by a set of friend accounts, the set of friend accounts associated with the context account in a connection graph of the social media platform;
identify, by the computer processor, nearby content broadcasted by a set of nearby accounts, the nearby content broadcasted from geographic locations proximate to the client geographic location;
merge the friend content and the nearby content to generate a result set;
remove duplicative content from the result set; and
provide at least a portion of the result set in response to the request.

15. The non-transitory computer-readable storage medium of claim 14, where the instructions further enable the computer processor to:
access a content repository, wherein the content repository organizes content according to density-based geohashing regions;
identify a current geohash region corresponding to the client geographic location and a set of geohash regions proximate to the current geohash region; and
identify the nearby content from the current geohash region and the set of geohash regions.

16. The non-transitory computer-readable storage medium of claim 15, where the instructions further enable the computer processor to add promoted content to a subset of the geohash regions.

17. The non-transitory computer-readable storage medium of claim 15, where the instructions further enable the computer processor to:
detect a set of geohash values corresponding to the geohash search region;
calculate a geohash search region using the geohash values; and
search the geohash search region to identify the nearby content.

18. The non-transitory computer-readable storage medium of claim 17, where the instructions further enable the computer processor to:
construct a density-based geohash tree using the set of geohash values, wherein each of the set of geohash values comprises a character length corresponding to a density of content in a geographic region.

19. The non-transitory computer-readable storage medium of claim 14, wherein the request comprises a timestamp, and wherein identifying the friend content further comprises:
identifying a friend queue corresponding to each of a plurality of user accounts; and
obtaining the friend content from the friend queues based on the timestamp.
